(19) United States
(12) Patent Application Publication
(10) Pub. No.: US 2019/0308551 A1
(43) Pub. Date: Oct. 10, 2019

(54) CUSTOMIZABLE BLACK OUT MARKER LIGHT

(71) Applicant: FNSS SAVUNMA SISTEMLERI ANONIM SIRKETI, Ankara (TR)

(72) Inventor: Ali Ozgu NURSAL, Ankara (TR)

(21) Appl. No.: 16/309,575

(22) PCT Filed: Jul. 14, 2017
(86) PCT No.: PCT/TR2017/050322

§ 371 Date: Dec. 13, 2018

(30) Foreign Application Priority Data
Jul. 25, 2016 (TR) 2016/10257

(51) Int. Cl. B60Q 1/50; F21S 43/14; H05B 33/08; B60Q 1/44; B60Q 1/28; B60Q 1/30; G01C 3/00

(52) U.S. Cl. CPC B60Q 1/50; F21S 43/14; H05B 33/0863; F21Y 2115/10; B60Q 1/28; B60Q 1/30; G01C 3/00; B60Q 1/44

(57) ABSTRACT

A black out marker light is used in the military arena and enables the drivers of the convoy to determine the distance of the vehicles from the vehicle in front or behind them. The black out marker light includes a microprocessor, which controls the operation of the LEDs, a LED screen used as light source, controlled by said microprocessor, on which the forms mentioned above are created, generated by the LEDs, the LEDs forming forms determined by the microprocessor, resulting in light emission or non-emissivity, depending on whether they are powered or not powered.

### TECHNICAL FIELD

The invention relates to black out marker lights used in the military arena.

### STATE OF THE ART

Black out marker lights are used by drivers and commanders as well as mounted on the vehicle in military land vehicles. Black out marker lights are used in all vehicles in the convoy and are fitted behind and in front of the vehicles. The purpose of using the black out marker light is to determine the distance between vehicles when light discipline is applied. The driver/commander identifies the vehicle distance ahead by means of the black out marker light, adjusts the speed according to being too close or too far. Let's say, for example, that the distance between two cars in a convoy is 50 meters. Also, on the black out marker lights, two square forms standing side by side indicate that the distance between the vehicles is 50 meters. If the driver looking at the car ahead of the car at a certain speed at the rear sees two square forms on the black out marker light on the vehicle ahead, it means that the distance between them is 50 meters and it means that they must protect the speed that they have. But if the driver of the rear vehicle sees a rectangular form on the vehicle ahead, it means that the distance between them is increasing and that the vehicle must increase its speed. The driver/commander can also determine whether there is a slowdown at the rear by following the same lamp in the rear vehicle. Black out marker light is used to determine the approximate distance between vehicles in the dark.

In the black out marker lights, the light source is arranged at fixed intervals and illuminates the outside from the space in a certain form. When looking at the light source from specific distances, separate lighting forms are seen/perceived as a single form. In this case the distance to the car is perceived.

In black out marker lights used in the present technique, the light source ranges are fixed and a certain number and the form which is the lighting resultant cannot be changed. Since the bulb is used in the present technique, the structure of the black out marker light is rough/large.

In the prior art research on the subject, U.S. Pat. No. 4,277,819, titled Dark Illumination for Vehicles, was encountered. This application refers to a system which, through one or more LEDs, produces a limited appearance and at the same time that requires very little power and produces less heat than the light bulb used as a light source. In the application U.S. Pat. No. 4,277,819, the product is identified with a certain number of LEDs located at predetermined distances. In the system subject to our invention, a more dynamic product is defined according to the application number U.S. Pat. No. 4,277,819 and the distance between the light emitting LEDs can be changed.

Another application found in prior art studies is the U.S. Pat. No. 2,380,691. This application also refers to a black out marker light used in the military field, such as the invention referred to in the present invention. In the application U.S. Pat. No. 2,380,691, the product is identified with a certain number of bulbs located at predetermined distances. In the system subject to our invention, a more dynamic product is defined according to the application number U.S. Pat. No. 4,277,819 and the distance between the light emitting LEDs can be changed.

As a result, due to the above-mentioned drawbacks and due to the inadequacy of the current solutions about the subject, in the related technical field, it is necessary to make a development that can change the follow-up distance-to-vehicle distance perceptions with a dynamic system when the light discipline is applied and offer different options to the commanders.

### PURPOSE OF THE INVENTION

The invention is based on inspiration from existing situations and aims to solve the above mentioned drawbacks.

The object of the invention is, through the use of LED display for the light source, since the LEDs that make up the LED screen are individually controllable/programmable (on/off), the desired forms can be created on the black out marker light.

Another object of the invention is to change the distance between forms which is formed on the LED screen.

Another object of the invention is to increase the number of forms and to form more than one distance detection sensor.

Another object of the invention is to change the color of the LED's.

To fulfill the purposes described above:
The microprocessor, which controls the operation of the LEDs,
used as light source; controlled by said microprocessor; depending on whether they are empowered or not, consequences thereof that they are lighting or not, said LEDs forming the forms determined by the microprocessor,
a LED screen (1), composed by said LEDs and said forms are formed thereon.

which is used in the military arena and which allows the drivers of the convoy to determine the distance of the vehicles, the vehicle in front or behind them.

Said black out marker light, in a preferred embodiment, comprises as said LED a RGB LED emitting a plurality of colors of light.

Said black out marker light comprises, in a preferred embodiment, a control interface box with a display/screen on which monitoring which one of said selections is selected and buttons for making color selection and/or the selection of forms loaded to the said microprocessor which reduces or increases the distance between said forms.

Said black out marker light, in a preferred embodiment, comprises a brake lamp which, in case of positioning the rear area of the vehicle, is lighting in case of braking and emitting light of a different color from the light emitted by said LEDs.

The structural and characteristic features and all advantages of the invention will be more clearly understood by the following drawings and the detailed description which is made by referring to these figures, and therefore the evaluation should be done in consideration of these figures and detailed explanation.

### FIGURES FOR BETTER UNDERSTANDING OF THE INVENTION

FIG. 1 is a view of the preferred embodiment of the LED display according to the invention.

FIG. 2 is a view of exemplary forms formed on the LED screen in the preferred embodiment of the LED screen of the invention.

FIG. 3 is an illustration of various forms formed in the preferred embodiment of the LED display of the invention.

FIG. 4 shows the drawings that the shape and the quantity of the LEDs can be changed (first figure from left) via the buttons on the control interface box and the control interface box (top), that it is possible to adjust the distance between the figures (the middle figure) and the color selection can be made (last figure).

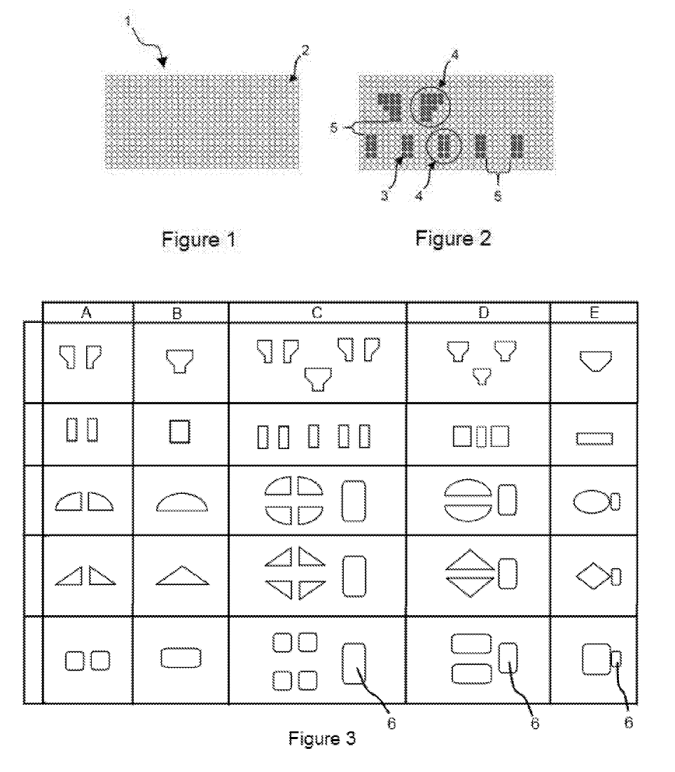

### EXPLANATION OF PART REFERENCES

1. LED display
2. Closed LED
3. Open LED
4. Form indicating the distance
5. Spacing between forms
6. Brake light
7. Remote interface box
71. Button
72. Display/indicator
A. 1. column
B. 2. column
C. 3. column
D. 4. column
E. 5. column
LED: Light Emitting Diode
RGB: Red Green Blue

The drawings do not necessarily have to be scaled and the details that are not necessary to understand the present invention may have been neglected. Furthermore, elements which are at least substantially identical or at least have substantially identical functions are indicated by the same number.

### DETAILED DESCRIPTION OF THE INVENTION

In this detailed description, preferred embodiments of the inventive black out marker light are disclosed only for better understanding of the present invention.

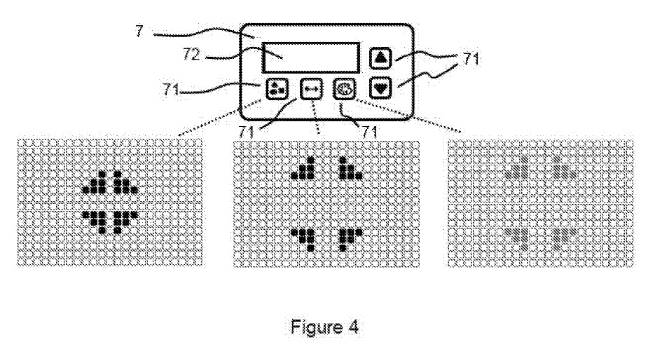

In the black out marker light according to the invention, in particular which is a new according to the present technique, there is a LED display (1) in the black out marker light. Said LED display (1) is composed of LEDs and the operation of said LEDs is controlled by the microprocessor. The microprocessor can be pre-programmed at the factory level and also the LEDs on the LED display (1) can be controlled via the control interface box (7). The black out marker light with the mentioned microprocessor can be used in factory settings without the control interface box (7). In such a case, it is used with a certain configuration, like the existing technical products. If desired, however, the black out marker light can also be used with said control interface box (7). There is on the control interface box (7), the buttons (71) which will make the color selection, make the selection of the pre-loaded form, reduce or increase the distance between the forms and a display/screen (72) indicating which of the selections is selected (FIG. 4).

In the black out marker light according to the invention, forms are formed on the LED screen (1) in which the LEDs emit light or do not emit light, depending on whether the LEDs are powered or not powered. According to the way in which the forms mentioned are seen, the distances between the vehicles are determined. The distance change with the said forms is done in the following way: the range that the user wants as loaded via the control interface box (7) or via the pre-factory microprocessor. That is, it will be determined which form is requested to be seen at which distance, and the necessary adjustment will be made. If the commander is to change the distance via the control interface box (7), he must be informed about the drivers of all the vehicles in the convoy and the information about which form is visible at which distance.

The LED display (1) consists of LEDs that provide sufficient resolution. With the LED display (1), the forms (4) indicating the desired distance can be formed in different colors. However, thanks to the LED screen (1), the spaces/distances between the forms (4) indicating the distance (the distance between the forms (5)) can be changed and the convoy tracking distance ranges can be changed. Furthermore, more than one distance range perception can be formed on said LED screen (1). The LEDs on the LED display (1) can be individually controlled by the microprocessor. Thus, when the LEDs (2) are not energized, the LEDs, which are not energized and are called the closed LED (2), are detected as background. The LEDs which are energized and which are called the open LEDs (3) provide the formation of the desired forms.

The relation between the inter-form distances (5) formed on the LED screen (1) and the follow-up distance is as follows: the angular difference required for the human eye to distinguish between two objects, which are dependent on various conditions, varies from about 0.08 to 0.17 degrees. The distance between the forms (5) can be calculated from the above-mentioned threshold in terms of the distance from which it will appear as a single form. Or vice versa the distance between the forms (5) can be adjusted so that it appears as a single form at the desired distance.

In FIG. 3, examples of various forms formed in the preferred embodiment of the LED display (1) of the invention are given. In FIG. 3, a form example is given in column (A). In column 2 (B) it shows how these forms are perceived as a single form at a specified distance. The forms shown in column 1 (A) and column 2 (B) are the view from the near and far distances of a black out marker light in front of the vehicle. In the 3. column (C), four-form LEDs as well as a brake lamp (6) are shown. Except for the brake lamp in column 3 (C), in the 3. column (C), in the fourth column (D) and in the 5. column (E), the forms in the light of the black out marker light to be found behind the vehicle have their appearance increasingly closer. Behind the vehicle there is a brake light (6), which is different from the front, in the black out marker lights and is lighting when the brake is applied. There are also 2 types of distance perception in the front black out marker lights, and 3 types of distance perception in the rear (near, medium, and far distances). It is shown how the forms found in the 4. column (D), 3. column are seen on the first step perimeter (i.e. 50 meters away) and in the 5. column (E) they will be seen on the second step forehead (i.e. 100 meters distance for example).

As the LED contained in the LED lamp of the present invention, color change can be performed by using LEDs of multicolor (for example, RGB LEDs). LEDs which are used as indicator lamps in normal use are indicated in red or orange color and LEDs that are lighting in braking are defined as amber color. There is a requirement of different colors between the brake and the constantly lit lamp. However, monochrome LEDs can also be used as LEDs in the inventive LED lamp. Since it is necessary to define a separate color for the brake in the black out marker light used behind the vehicle, in the back of the car, RGB type LED is needed but in front of the vehicle, it is possible to use monochrome LED to reduce the product cost in the black out marker light (there is no need to use RGB LED). If desired, however, the rearward vehicle can also increase communication between the two vehicles by sending different color signals to the leading vehicle.

1. A black out marker light used in the military arena and which allows the drivers of the convoy to determine the distance of the vehicles, the vehicle in front or behind them, characterized in that; it comprises;
a microprocessor which controls the operation of LEDs;
said LEDs, which are used as a light source, controlled by said microprocessor, forming the forms determined by the microprocessor, depending on whether they are empowered or not, consequences thereof that they are lighting or not; and
a LED screen composed by said LEDs and said forms are formed thereon.

2. A black out marker light according to claim 1, characterized in that; said LEDs comprise a plurality of RGB LEDs emitting light in different colors.

3. A black out marker light according to claim 1, characterized in comprising:
buttons which reduces or increases the distance between said forms, which allows selection of form shapes and/or color selection loaded to the said microprocessor; and
a display/screen indicating which of said selections is selected;
comprises a control interface box.

4. A black out marker light according to claim 1, characterized in that:
the black out marker light comprises a brake lamp which, in case of positioning on the rear area of the vehicle, is lighting in case of braking and emitting light of a different color from the light emitted by said LEDs.
